(19) United States
(12) Patent Application Publication
(10) Pub. No.: US 2015/0351997 A1
(43) Pub. Date: Dec. 10, 2015

(54) SYSTEM AND METHOD FOR CONTROLLING AIR MASSAGE PRESSURE USING VARIABLE FREQUENCY

(71) Applicants: KEVIN LE, RICHLAND HILLS, TX (US); THANH LE, GRAND PRAIRIE, TX (US); MANTHAN SHETH, ARLINGTON, TX (US)

(72) Inventors: KEVIN LE, RICHLAND HILLS, TX (US); THANH LE, GRAND PRAIRIE, TX (US); MANTHAN SHETH, ARLINGTON, TX (US)

(73) Assignee: LURACO TECHNOLOGIES, INC., ARLINGTON, TX (US)

(21) Appl. No.: 14/296,451

(22) Filed: Jun. 4, 2014

(51) Int. Cl. A61H 9/00

(52) U.S. Cl. CPC A61H 9/0078

(57) ABSTRACT

A system and a method for controlling air massage pressure using variable frequency are disclosed. The system and method allow a user of a massage chair to adjust the air massage pressure to any desired level electronically. Air compressor power is controlled by varying the frequency of the power supply. The air pressure is monitored by a pressure sensor that forms a closed loop feedback control. This design allows for fast response and smooth pressure control. In an embodiment of an aspect of the present invention, a system for controlling air massage pressure using variable frequency includes at least one air compressor, a master control board that includes or is equivalent to a variable frequency controller and a controller interface associated with the variable frequency controller, and a pressure sensor. The system may also include a temperature sensor, a current sensor, a power source, and/or a remote control.

### BACKGROUND OF THE INVENTION

1. Field of the Invention

The present invention generally relates to massage chairs, and massage devices, apparatuses and systems used in providing the massaging effects in massage chairs. More specifically, the present invention is directed to a system and a method for controlling air massage pressure using variable frequency.

2. Description of the Related Art

Massage chairs, and massage devices, apparatuses and systems used in providing the massaging effects in massage chairs are known in the art.

The present invention overcomes one or more of the shortcomings of the prior art. The Applicant is unaware of inventions or patents, taken either singly or in combination, which are seen to describe the present invention as claimed.

### SUMMARY OF THE INVENTION

The present invention is a system and a method for controlling air massage pressure using variable frequency. The system and method allow a user of a massage chair to adjust the air massage pressure to any desired level electronically. Air compressor power is controlled by varying the frequency of the power supply. The air pressure is monitored by a pressure sensor that forms a closed loop feedback control. This design allows for fast response and smooth pressure control.

In an embodiment of an aspect of the present invention, a system for controlling air massage pressure using variable frequency includes at least one air compressor, a master control board that includes or is equivalent to a variable frequency controller and a controller interface associated with the variable frequency controller, and a pressure sensor. The system may also include a temperature sensor, a current sensor, and/or a power source. The system may further include a remote control.

In another aspect of the present invention, a method for controlling air massage pressure using variable frequency is disclosed in detail in another section of the present application.

### BRIEF DESCRIPTION OF THE DRAWINGS

FIG. 1 is a perspective view of a massage chair that includes an embodiment of a system for controlling air massage pressure using variable frequency according to the present invention;

FIG. 2 is a block diagram of an embodiment of a system for controlling air massage pressure using variable frequency according to the present invention;

FIG. 3 is a schematic block diagram of an embodiment of a system for controlling air massage pressure using variable frequency according to the present invention, showing the relationships or associations of the different electrical components of the system; and

FIG. 4 is a block diagram of an embodiment of a method for controlling air massage pressure using variable frequency according to the present invention.

It should be understood that the above-attached figures are not intended to limit the scope of the present invention in any way.

### DETAILED DESCRIPTION OF THE PRESENT INVENTION

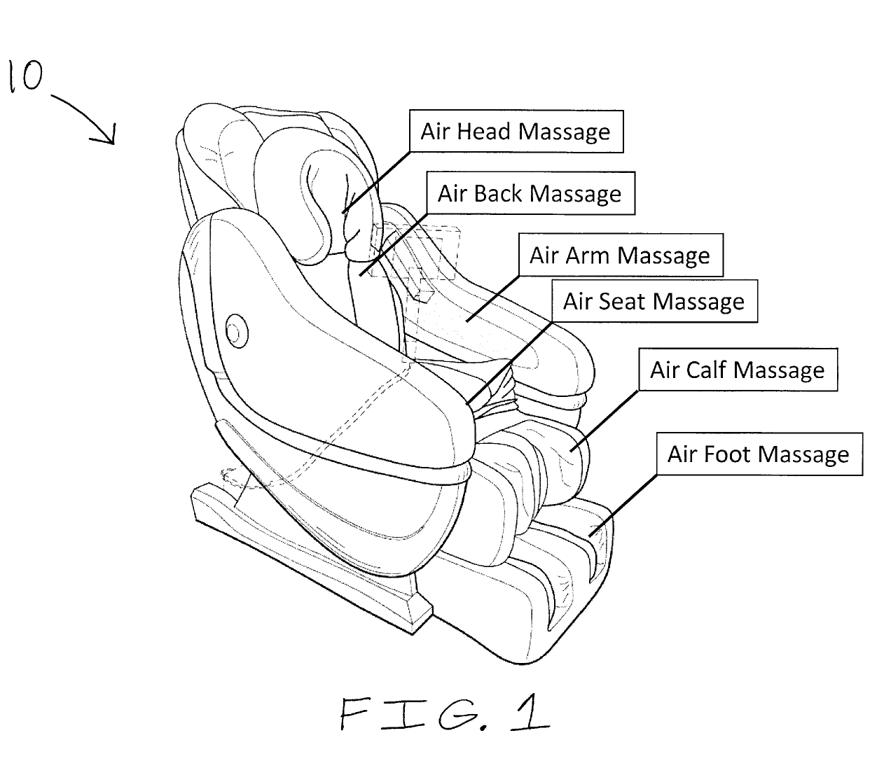

Referring to FIGS. 1-4, the present invention is a system 100 for controlling air massage pressure using variable frequency, and a method 200 for controlling air massage pressure using variable frequency. The system 100 and method 200 allow a user of a massage chair 10 to adjust the air massage pressure to any desired level electronically. Air compressor power is controlled by varying the frequency of the power supply. The air pressure is monitored by a pressure sensor that forms a closed loop feedback control. This design allows for fast response and smooth pressure control.

Referring to FIG. 1, a massage chair 10 comprises an embodiment of a system 100 for controlling air massage pressure using variable frequency according to the present invention. The system 100 allows a user (not shown) of the massage chair 10 to adjust the air massage pressure to any desired level electronically such that the user is able to receive desired air pressure massages directed to the user's head, back, arms, hands, seat, calfs, and/or feet. The air massage pressure can be adjusted to any desired level electronically by varying the frequency of the power supply.

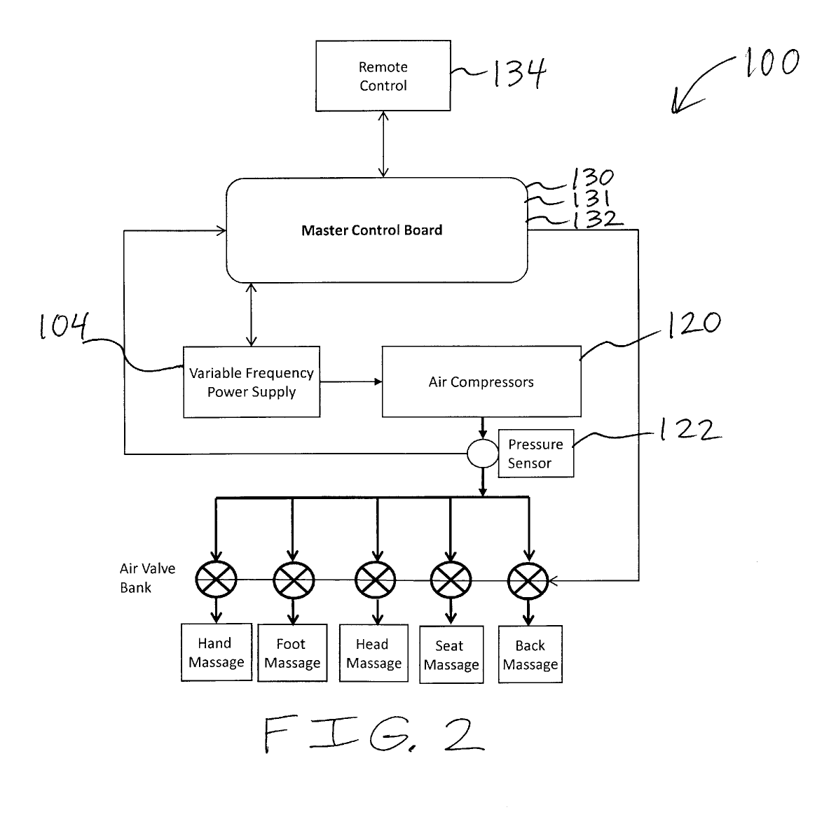

Referring to FIG. 2, illustrated is a block diagram of the system 100 for controlling air massage pressure using variable frequency.

In an embodiment, the system 100 includes at least one air compressor 120, a master control board (MCB) 130 that includes or is equivalent to a variable frequency controller 131 and a controller interface 132 associated with the variable frequency controller 131, and a pressure sensor 122. The system 100 may also include a temperature sensor 108, a current sensor 112, and/or a power source 104. The system 100 may further include a remote control 134.

The air compressor 120 is operable to pump air massage pressure to desired locations in a massage chair 10 so as to provide a user of the massage chair 10 with air pressure massage.

The variable frequency controller 131 is adapted for receiving a power supply voltage having a first frequency from a power source 104. The variable frequency controller 131 is associated with the air compressor 120.

The controller interface 132 is associated with the variable frequency controller 131. The controller interface 132 is adapted for receiving a first selection of a first button.

The pressure sensor 122 is operable to sense air pressure associated with the massage chair 10 and the air compressor 120.

After determining that the pressure sensor 122 is present, the variable frequency controller 131 determines whether the air pressure associated with the massage chair 10 and the air compressor 120 is equal to or greater than a predetermined level that is sufficient to operate the air compressor 120.

After determining that the air pressure associated with the massage chair 10 and the air compressor 120 is equal to or greater than the predetermined level, the variable frequency controller 131 starts the air compressor 120 at a first air compressor frequency such that the air compressor 120 outputs air pressure at a first air pressure.

After starting the air compressor 120 at the first air compressor frequency such that the air compressor 120 outputs air pressure at the first air pressure, the controller interface 132 associated with the variable frequency controller 131 receives a selection of a second button that is different than the first button.

After receiving at the controller interface 132 associated with the variable frequency controller 131 the selection of the second button, the variable frequency controller 131 converts the first frequency of the power supply voltage to a second frequency such that the air compressor 120 operates at a second air compressor frequency and the air compressor 120 outputs air pressure at a second air pressure. The second air compressor frequency is different from the first air compressor frequency, and the second air pressure is different from the first air pressure.

After converting by the variable frequency controller 131 the first frequency of the power supply voltage to the second frequency, the controller interface 132 associated with the variable frequency controller 131 receives a selection of a third button that is different than the first and second buttons.

After receiving at the controller interface 132 associated with the variable frequency controller 131 the selection of the third button, the variable frequency controller 131 converts the second frequency of the power supply voltage to a third frequency such that the air compressor 120 operates at a third air compressor frequency and the air compressor 120 outputs air pressure at a third air pressure. The third air compressor frequency is different from the first and second air compressor frequencies, and the third air pressure is different from the first and second air pressures.

After converting by the variable frequency controller 131 the second frequency of the power supply voltage to the third frequency, the controller interface 132 associated with the variable frequency controller 131 receives a second selection of the first button such that the variable frequency controller 131 shuts down operation of the air compressor 120 in response to the second selection of the first button.

After receiving at the controller interface 132 associated with the variable frequency controller 131 the first selection of the first button, an auxiliary power port associated with the variable frequency controller 131 is powered on.

After receiving at the controller interface 132 associated with the variable frequency controller 131 the second selection of the first button, the controller interface 132 associated with said variable frequency controller 131 receives a third selection of the first button such that the variable frequency controller 131 powers off the auxiliary power port in response to the third selection of the first button.

As a non-limiting example, the second air compressor frequency is less than the first air compressor frequency, the third air compressor frequency is greater than the second air compressor frequency, and the third air compressor frequency is less than the first air compressor frequency.

As a non-limiting example, the first button is a power button, the second button is a decrease air pressure button, and the third button is an increase air pressure button.

The temperature sensor 108 is operable to sense temperature associated with the air compressor 120. The variable frequency controller 131 determines whether a temperature associated with the air compressor 120 is equal to or greater than a temperature threshold, and the variable frequency controller 131 shuts down operation of the air compressor 120 when the variable frequency controller 131 determines that the temperature associated with the air compressor 120 is equal to or greater than the temperature threshold.

The current sensor 112 is operable to sense current associated with the air compressor 120. The variable frequency controller 131 determines whether a current associated with the air compressor 120 is equal to or greater than a current threshold, and the variable frequency controller 131 shuts down operation of the air compressor 120 when the variable frequency controller 131 determines that the current associated with the air compressor 120 is equal to or greater than the current threshold.

The remote control 134 is operable by the user to communicate with the master control board (MCB) 130 such that the user is able to receive desired air pressure massages directed to the user's head, back, arms, hands, seat, calfs, and/or feet.

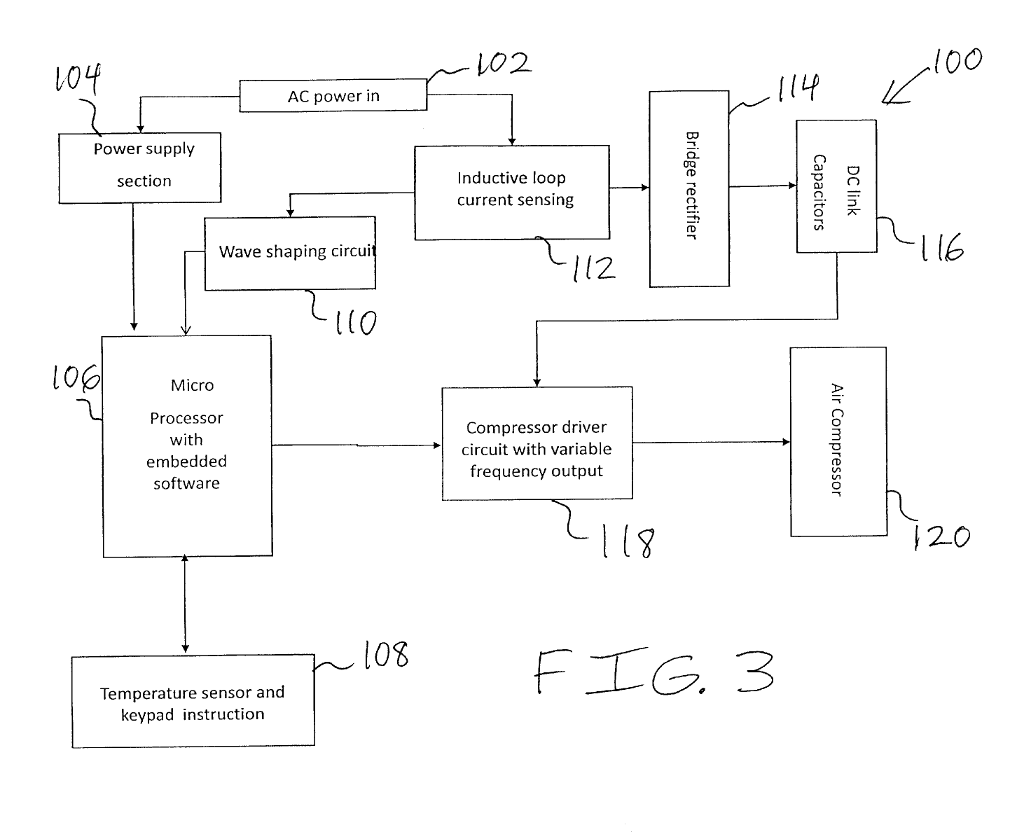

Referring to FIG. 3, illustrated is a schematic block diagram of an embodiment of a system 100 for controlling air massage pressure using variable frequency according to the present invention, showing the relationships or associations of the different electrical components of the system 100.

The system 100 may include AC power 102, a power supply section having a power source 104, a micro processor 106 with embedded software, a temperature sensor 108 and keypad instruction, a wave shaping circuit 110, an inductive loop current sensor 112, a bridge rectifier 114, DC link capacitors 116, a compressor driver circuit 118 with variable frequency output, and at least one air compressor 120.

The AC power 102 may be any AC power known in the art.

The power source 104 may be a plug-in power cord system or a rechargeable battery. The power source 104 may also be any power source known in the art.

The micro processor 106 may be any micro processor known in the art.

The temperature sensor 108 may be any temperature sensor known in the art.

The wave shaping circuit 110 may be any wave shaping circuit known in the art.

The current sensor 112 may be any current sensor known in the art.

The bridge rectifier 114 may be any bridge rectifier known in the art.

The DC link capacitors 116 may be any DC link capacitors known in the art.

The compressor driver circuit 118 with variable frequency output may be any compressor driver circuit with variable frequency output known in the art.

The air compressor 120 may be any air compressor known in the art.

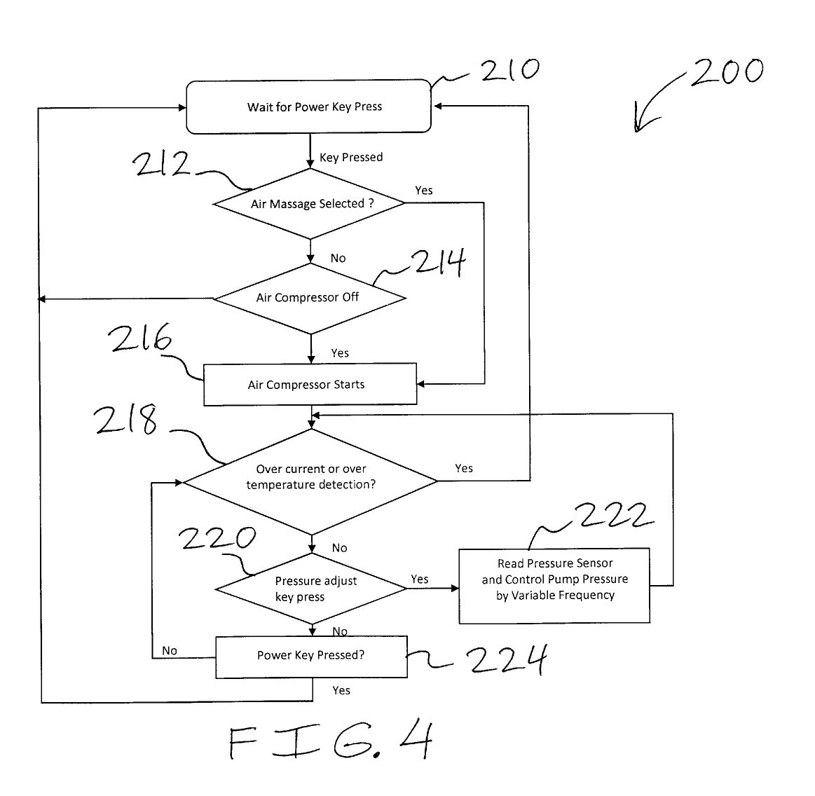

Referring to FIG. 4, illustrated is a flowchart of a method 200 for controlling air massage pressure using variable frequency in accordance with an embodiment. The method 200 begins in block 210, where power for a system 100 for controlling air massage pressure using variable frequency will be activated or powered on by a user pressing or selecting a power key, button or selection. Power for the system 100 may be provided by various types of power sources 104.

If the power key is pressed or selected, the method 200 continues in block 212, where an air massage key may be pressed or selected by the user. When the air massage key is pressed or selected, an air compressor 120 starts or is powered on, as shown in block 216. However, if the air massage key is not pressed nor selected, the air compressor 120 stays off, as shown in block 214.

After the air compressor 120 starts or is powered on, the method 200 continues in block 218, where determination is made as to whether there is detection of over current or over temperature. If over current or over temperature is not detected via the use of a temperature sensor 108 or current sensor 112, respectively, the method 200 continues to block 220, where a pressure adjust key may be pressed or selected by the user. However, if over current or over temperature is detected, the method 200 returns to block 210.

If the pressure adjust key is pressed or selected by the user, the method 200 continues in block 222, where a pressure sensor 122 is read and applicable air massage pressure being pumped or provided to at least one desired massage location, such as the head, back, arm, seat, calf, and/or feet, by the air compressor 120 is controlled by varying the frequency of the power supply or source 104. After block 222, the method returns to block 218. However, if the pressure adjust key is not pressed nor selected by the user, the method 200 continues in block 224, where the power key may be pressed or selected by the user. If the power key is not pressed nor selected by the user, the method returns to block 218. On the other, hand, if the power key is pressed or selected by the user, the method returns to block 210. The pressure sensor 122 may be any pressure sensor known in the art.

It is to be understood that the present invention is not limited to the embodiments described above or as shown in the attached figures, but encompasses any and all embodiments within the spirit of the invention.

What is claimed is:

1. A method for controlling air massage pressure using variable frequency, the method comprising the steps of:
receiving at a variable frequency controller a power supply voltage having a first frequency, wherein the variable frequency controller is associated with at least one air compressor that is operable to pump air massage pressure to at least one desired location in a massage chair so as to provide a user of the massage chair with air pressure massage;
receiving at a controller interface associated with the variable frequency controller a first selection of a first button;
after receiving at the controller interface associated with the variable frequency controller the first selection of the first button, determining by the variable frequency controller whether a pressure sensor is present, wherein the pressure sensor is operable to sense air pressure associated with the massage chair and the air compressor;
after determining by the variable frequency controller that the pressure sensor is present, determining whether the air pressure associated with the massage chair and the air compressor is equal to or greater than a predetermined level that is sufficient to operate the air compressor;
after determining that the air pressure associated with the massage chair and the air compressor is equal to or greater than the predetermined level, starting the air compressor at a first air compressor frequency such that the air compressor outputs air pressure at a first air pressure;
after starting the air compressor at the first air compressor frequency such that the air compressor outputs the air pressure at the first air pressure, receiving at the controller interface associated with the variable frequency controller a selection of a second button that is different than the first button;
after receiving at the controller interface associated with the variable frequency controller the selection of the second button, converting by the variable frequency controller the first frequency of the power supply voltage to a second frequency such that the air compressor operates at a second air compressor frequency and the air compressor outputs air pressure at a second air pressure, wherein the second air compressor frequency is different from the first air compressor frequency, and wherein the second air pressure is different from the first air pressure;
after converting by the variable frequency controller the first frequency of the power supply voltage to the second frequency, receiving at the controller interface associated with the variable frequency controller a selection of a third button that is different than the first and second buttons;
after receiving at the controller interface associated with the variable frequency controller the selection of the third button, converting by the variable frequency controller the second frequency of the power supply voltage to a third frequency such that the air compressor operates at a third air compressor frequency and the air compressor outputs air pressure at a third air pressure, wherein the third air compressor frequency is different from the first and second air compressor frequencies, and wherein the third air pressure is different from the first and second air pressures; and
after converting by the variable frequency controller the second frequency of the power supply voltage to the third frequency, receiving at the controller interface associated with the variable frequency controller a second selection of the first button such that the variable frequency controller shuts down operation of the air compressor in response to the second selection of the first button.

2. The method according to claim 1, further comprising: determining by the variable frequency controller whether a temperature associated with the air compressor is equal to or greater than a temperature threshold; and shutting down operation of the air compressor when the variable frequency controller determines that the temperature associated with the air compressor is equal to or greater than the temperature threshold.

3. The method according to claim 1, further comprising: determining by the variable frequency controller whether a current associated with the air compressor is equal to or greater than a current threshold; and shutting down operation of the air compressor when the variable frequency controller determines that the current associated with the air compressor is equal to or greater than the current threshold.

4. The method according to claim 1, further comprising after receiving at the controller interface associated with the variable frequency controller the first selection of the first button, powering on an auxiliary power port associated with the variable frequency controller; and after receiving at the controller interface associated with the variable frequency controller the second selection of the first button, receiving at the controller interface associated with the variable frequency controller a third selection of the first button such that the variable frequency controller powers off the auxiliary power port in response to the third selection of the first button.

5. The method according to claim 1, wherein the second air compressor frequency is less than the first air compressor frequency, wherein the third air compressor frequency is greater than the second air compressor frequency, and wherein the third air compressor frequency is less than the first air compressor frequency.

6. The method according to claim 1, wherein the first button is a power button, wherein the second button is a decrease air pressure button, and wherein the third button is an increase air pressure button.

7. A method for controlling air massage pressure using variable frequency, the method comprising the steps of:
activating or powering on power for a system for controlling air massage pressure using variable frequency;
deciding whether or not to press or select an air massage key, wherein an air compressor starts or is powered on when the air massage key is pressed nor selected, and wherein the air compressor stays off if the air massage key is not pressed nor selected;
after the air compressor starts or is powered on, determining as to whether there is detection of over current or over temperature, wherein if over current or over temperature is not detected, the method continues where a pressure adjust key may be pressed or selected by the user, and wherein the method returns to the step of activating or powering on power if over current or over temperature is detected; and
deciding whether or not to press or select the pressure adjust key by the user, wherein the method continues if the pressure adjust key is press or selected such that a pressure sensor is read and applicable air massage pressure being pumped or provided to at least one desired massage location by the air compressor is controlled by varying the frequency of the power supply or source, wherein returning the method to the step of determination is made as to whether there is detection of over current or over temperature after the pressure adjustment, and
wherein if the pressure adjust key is not pressed nor selected by the user, the method continues where the power key may be pressed or selected by the user, wherein if the power key is not pressed nor selected by the user, the method returns to the step of determination is made as to whether there is detection of over current or over temperature, and wherein if the power key is pressed or selected by the user, the method returns to the step of activating or powering on power.

8. A system for controlling air massage pressure using variable frequency, said system comprising:
at least one air compressor operable to pump air massage pressure to desired locations in a massage chair so as to provide a user of the massage chair with air pressure massage;
a variable frequency controller adapted for receiving a power supply voltage having a first frequency, wherein said variable frequency controller is associated with said air compressor;
a controller interface associated with said variable frequency controller, wherein said controller interface is adapted for receiving a first selection of a first button; and
a pressure sensor operable to sense air pressure associated with the massage chair and said air compressor,
wherein after determining by said variable frequency controller that said pressure sensor is present, determining whether the air pressure associated with the massage chair and said air compressor is equal to or greater than a predetermined level that is sufficient to operate said air compressor,
wherein after determining that the air pressure associated with the massage chair and said air compressor is equal to or greater than the predetermined level, starting said air compressor at a first air compressor frequency such that said air compressor outputs air pressure at a first air pressure,
wherein after starting said air compressor at said first air compressor frequency such that said air compressor outputs air pressure at said first air pressure, receiving at said controller interface associated with said variable frequency controller a selection of a second button that is different than said first button,
wherein after receiving at said controller interface associated with said variable frequency controller said selection of said second button, converting by said variable frequency controller the first frequency of the power supply voltage to a second frequency such that said air compressor operates at a second air compressor frequency and said air compressor outputs air pressure at a second air pressure, wherein said second air compressor frequency is different from said first air compressor frequency, and wherein said second air pressure is different from said first air pressure,
wherein after converting by said variable frequency controller the first frequency of the power supply voltage to the second frequency, receiving at said controller interface associated with said variable frequency controller a selection of a third button that is different than said first and second buttons,
wherein after receiving at said controller interface associated with said variable frequency controller said selection of said third button, converting by said variable frequency controller the second frequency of the power supply voltage to a third frequency such that said air compressor operates at a third air compressor frequency and said air compressor outputs air pressure at a third air pressure, wherein said third air compressor frequency is different from said first and second air compressor frequencies, and wherein said third air pressure is different from said first and second air pressures, and
wherein after converting by said variable frequency controller the second frequency of the power supply voltage to the third frequency, receiving at said controller interface associated with said variable frequency controller a second selection of said first button such that said variable frequency controller shuts down operation of said air compressor in response to said second selection of said first button.

9. The system according to claim 8, wherein after receiving at said controller interface associated with said variable frequency controller said first selection of said first button, powering on an auxiliary power port associated with said variable frequency controller, and wherein after receiving at said controller interface associated with said variable frequency controller said second selection of said first button, receiving at said controller interface associated with said variable frequency controller a third selection of said first button such that said variable frequency controller powers off said auxiliary power port in response to said third selection of said first button.

10. The system according to claim 8, wherein said second air compressor frequency is less than said first air compressor frequency, wherein said third air compressor frequency is greater than said second air compressor frequency, and wherein said third air compressor frequency is less than said first air compressor frequency.

11. The system according to claim 8, wherein said first button is a power button, wherein said second button is a decrease air pressure button, and wherein said third button is an increase air pressure button.

12. The system according to claim 8, further comprising a temperature sensor operable to sense temperature associated with said air compressor, wherein said variable frequency controller determines whether a temperature associated with said air compressor is equal to or greater than a temperature threshold, and wherein said variable frequency controller shuts down operation of said air compressor when said variable frequency controller determines that said temperature associated with said air compressor is equal to or greater than said temperature threshold.

13. The system according to claim 12, further comprising a current sensor operable to sense current associated with said air compressor, wherein said variable frequency controller determines whether a current associated with said air compressor is equal to or greater than a current threshold, and wherein said variable frequency controller shuts down operation of said air compressor when said variable frequency controller determines that said current associated with said air compressor is equal to or greater than said current threshold.

14. The system according to claim 8, further comprising a current sensor operable to sense current associated with said air compressor, wherein said variable frequency controller determines whether a current associated with said air compressor is equal to or greater than a current threshold, and wherein said variable frequency controller shuts down operation of said air compressor when said variable frequency controller determines that said current associated with said air compressor is equal to or greater than said current threshold.

15. The system according to claim 8, further comprising a power source.

16. The system according to claim 8, further comprising at least one of AC power, a power source, a micro processor with embedded software, a temperature sensor and keypad instruction, a wave shaping circuit, an inductive loop current sensor, a bridge rectifier, DC link capacitors, a compressor driver circuit with variable frequency output, and any combination thereof.
